(19) United States
(12) Patent Application Publication
(10) Pub. No.: US 2026/0311522 A1
(43) Pub. Date: Oct. 8, 2026

(54) SYSTEMS AND METHODS FOR ANALYZING VEHICLE FUEL CONSUMPTION PATTERNS USING MULTI-SOURCE DATA CORRELATION

(71) Applicant: MOTIVE TECHNOLOGIES, INC., San Francisco, CA (US)

(72) Inventors: Hemant BANAVAR, Berkeley, CA (US); Siva Gurusamy SIVANESAN, Fremont, CA (US); Dhruvi SINGH, Indore (IN); Prahadeesh GIRIDHARAN, Chennai (IN); Sophie TANG, San Francisco, CA (US); Shravan SUNKADA, Richmond, CA (US); Siddharth RAMESH, Chengalpattu (IN); Vijay Kumar NAMBALA, Bengaluru (IN); Bhupinder SINGH, Patiala (IN)

(21) Appl. No.: 19/172,835

(22) Filed: Apr. 8, 2025

(51) Int. Cl. G07C 5/00; G06V 20/59; G06V 40/16; G07C 5/08

(52) U.S. Cl. CPC G07C 5/008; G06V 20/59; G06V 40/172; G07C 5/0808

(57) ABSTRACT

The techniques described herein relate to a system including: a vehicle including: a fuel container; a vehicle gateway device coupled to a fuel level sensor configured to generate fuel level signals and configured to transmit fuel level sensor data; and a camera system configured to capture driver identification data; and a remote computing system including a processor and a memory storing instructions that, when executed by the processor, cause the processor to: receive the fuel level sensor data from the vehicle gateway device; collect fluid dispensing event data; compare changes in the fuel level sensor data with fluid volume amounts to establish a sensor calibration ratio; identify maximum fill patterns across multiple fluid level change events; compute a confidence score based on consistency of the maximum fill patterns; determine a container capacity when the confidence score exceeds a threshold; and validate fluid dispensing operations using the container capacity.

### BACKGROUND

Commercial vehicle fleets commonly utilize various telematics systems to monitor and manage their operations. These systems typically include vehicle gateways that interface with vehicle sensors to collect operational data, including data from fuel level sensors that monitor fuel tank levels. The fuel level sensors in modern vehicles generally operate using float mechanisms connected to measurement sensors, which convert the physical position of the float into electrical signals processed by the vehicle's Engine Control Unit (ECU).

Fleet vehicles often implement fuel payment systems that enable drivers to purchase fuel for their assigned vehicles. These payment systems typically integrate with merchant point-of-sale systems and payment networks to process fuel purchase transactions. Fuel dispensing event data from these systems includes basic information such as the purchase amount, time, and merchant location.

### BRIEF DESCRIPTION OF THE FIGURES

FIG. 1 is a block diagram illustrating a system for analyzing vehicle refueling patterns according to some of the disclosed embodiments.

FIG. 2 is a flow diagram illustrating a method for determining vehicle fuel tank capacity using sensor data analysis according to some of the disclosed embodiments.

FIG. 3 is a flow diagram illustrating a method for validating transaction locations using real-time vehicle position data according to some of the disclosed embodiments.

FIG. 4 is a flow diagram illustrating a method for establishing driver-vehicle mappings using multiple data sources according to some of the disclosed embodiments.

FIG. 5 is a block diagram of a computing device according to some embodiments of the disclosure.

### DETAILED DESCRIPTION

Global Positioning System (GPS) technology is widely used in fleet management to track vehicle locations. GPS receivers in vehicles or mobile devices calculate position by measuring the time it takes for signals to travel from multiple satellites to the receiver. However, GPS signals can be affected by various environmental factors such as atmospheric conditions and signal multipath, which can impact location accuracy.

Many fleet vehicles are equipped with after-market auxiliary or modified fuel tanks to extend their operating range. These modifications can alter the relationship between fuel level sensor readings and actual fuel volumes, as the sensors are typically calibrated for standard factory-installed tanks. The presence of these modified tanks introduces complexity in interpreting fuel level sensor data.

Mobile devices and applications are increasingly used in fleet operations for various purposes including driver identification and location tracking. These applications typically utilize device sensors such as GPS and can establish connections with vehicle systems through protocols such as Bluetooth Low Energy (BLE).

Camera systems are also becoming common in commercial vehicles, often used for safety monitoring and driver identification. These systems may incorporate various types of image sensors and can be connected to onboard processing units for real-time analysis.

Existing vehicle telematics systems face significant technical challenges in establishing accurate correlations between fuel level sensor data and actual fuel tank capacities. This challenge is compounded by the inherent limitations of fuel level sensors, which provide non-linear signals that vary based on tank geometry and sensor placement. When vehicles are modified with auxiliary or custom fuel tanks, the original sensor calibration becomes invalid, making it impossible to rely on manufacturer specifications. Additionally, the technical limitations of GPS accuracy in urban environments and the variable quality of merchant location data make it difficult to establish reliable spatial relationships between vehicles and fuel dispensing locations. These technical constraints are further complicated by the challenge of maintaining accurate real-time driver-vehicle mappings across multiple independent data streams with varying levels of reliability and temporal consistency.

The disclosed embodiments address these technical challenges through a multi-source data correlation system. The system implements adaptive sensor calibration algorithms that dynamically learn tank characteristics by analyzing patterns in fuel level sensor signals during refueling events, enabling accurate capacity determination without requiring prior human knowledge of tank specifications. The system employs spatial validation processors that combine real-time vehicle telemetry with historical transaction patterns to build confidence scores for merchant locations, compensating for GPS accuracy limitations in different environments. To maintain reliable driver-vehicle relationships, the system implements a hierarchical correlation engine that processes multiple concurrent data streams including authenticated device pairings, computer vision analysis, and location data, assigning calibrated confidence levels to different correlation methods. These technical components work together through a centralized processing engine that maintains temporal synchronization across all data streams while continuously refining its correlation models based on accumulated sensor data.

In some implementations, the techniques described herein relate to a system including: a vehicle including: a fuel container; a vehicle gateway device coupled to a fuel level sensor configured to generate fuel level signals and configured to transmit fuel level sensor data; and a camera system configured to capture driver identification data; and a remote computing system including a processor and a memory storing instructions that, when executed by the processor, cause the processor to: receive the fuel level sensor data from the vehicle gateway device; collect fluid dispensing event data; compare changes in the fuel level sensor data with fluid volume amounts to establish a sensor calibration ratio; identify maximum fill patterns across multiple fluid level change events; compute a confidence score based on consistency of the maximum fill patterns; determine a container capacity when the confidence score exceeds a threshold; and validate fluid dispensing operations using the container capacity.

In some implementations, the techniques described herein relate to a system, wherein identifying maximum fill patterns includes: detecting stable periods in the fuel level sensor data during refueling events; filtering out sensor readings caused by fuel movement; and clustering stable sensor readings to identify consistent maximum levels.

In some implementations, the techniques described herein relate to a system, the instructions further causing the processor to perform the steps of: receiving a vehicle location from the vehicle gateway device; obtaining a merchant location associated with the fuel dispensing event data; calculating a distance between the vehicle location and the merchant location; and validating the fuel dispensing event data based on the distance.

In some implementations, the techniques described herein relate to a system, the instructions further causing the processor to perform the steps of: detecting a connection between a driver application and the vehicle gateway device; receiving image data from an AI camera system in a vehicle; performing driver identification analysis on the image data; and establishing a driver-vehicle correlation based on at least one of: the connection or the driver identification analysis.

In some implementations, the techniques described herein relate to a system, wherein establishing the driver-vehicle correlation includes assigning a confidence level based on a plurality of verification methods.

In some implementations, the techniques described herein relate to a system, wherein computing the confidence score includes: analyzing variations in the sensor calibration ratio across multiple refueling events; determining a statistical consistency of maximum fill levels; and adjusting the confidence score based on a number of analyzed refueling events.

In some implementations, the techniques described herein relate to a system, wherein validating fuel dispensing operations includes: receiving a new fuel purchase amount; comparing the new fuel purchase amount to an expected tank level change based on the fuel container capacity; and generating a response to the fuel dispensing operations in response to comparing the new fuel purchase amount to the expected tank level change.

In some implementations, the techniques described herein relate to a method including: receiving, by a processor, fuel level sensor data from a vehicle gateway device, the vehicle gateway device communicatively couple to a fuel system of a vehicle via a diagnostic port; collecting, by the processor, fuel dispensing event data; comparing, by the processor, changes in the fuel level sensor data with fuel volume amounts to establish a sensor calibration ratio; identifying, by the processor, maximum fill patterns across multiple fuel level change events; computing, by the processor, a confidence score based on consistency of the maximum fill patterns; determining, by the processor, a fuel container capacity when the confidence score exceeds a threshold; and validating, by the processor, fuel dispensing operations using the fuel container capacity.

In some implementations, the techniques described herein relate to a method, wherein identifying maximum fill patterns includes: detecting stable periods in the fuel level sensor data during refueling events; filtering out sensor readings caused by fuel movement; and clustering stable sensor readings to identify consistent maximum levels.

In some implementations, the techniques described herein relate to a method, further including: receiving a vehicle location from the vehicle gateway device; obtaining a merchant location associated with the fuel dispensing event data; calculating a distance between the vehicle location and the merchant location; and validating the fuel dispensing event data based on the distance.

In some implementations, the techniques described herein relate to a method, further including: detecting a connection between a driver application and the vehicle gateway device; receiving image data from an AI camera system in a vehicle; performing driver identification analysis on the image data; and establishing a driver-vehicle correlation based on at least one of: the connection or the driver identification analysis.

In some implementations, the techniques described herein relate to a method, wherein establishing the driver-vehicle correlation includes assigning a confidence level based on a plurality of verification methods.

In some implementations, the techniques described herein relate to a method, wherein computing the confidence score includes: analyzing variations in the sensor calibration ratio across multiple refueling events; determining a statistical consistency of maximum fill levels; and adjusting the confidence score based on a number of analyzed refueling events.

In some implementations, the techniques described herein relate to a method, wherein validating fuel dispensing operations includes: receiving a new fuel purchase amount; comparing the new fuel purchase amount to an expected tank level change based on the fuel container capacity; and generating a response to the fuel dispensing operations in response to comparing the new fuel purchase amount to the expected tank level change.

In some implementations, the techniques described herein relate to a non-transitory computer-readable storage medium for tangibly storing computer program instructions capable of being executed by a computer processor, the computer program instructions defining steps of: receiving fuel level sensor data from a vehicle gateway device, the vehicle gateway device communicatively couple to a fuel system of a vehicle via a diagnostic port; collecting fuel dispensing event data; comparing changes in the fuel level sensor data with fuel volume amounts to establish a sensor calibration ratio; identifying maximum fill patterns across multiple fuel level change events; computing a confidence score based on consistency of the maximum fill patterns; determining a fuel container capacity when the confidence score exceeds a threshold; and validating fuel dispensing operations using the fuel container capacity.

In some implementations, the techniques described herein relate to a non-transitory computer-readable storage medium, wherein identifying maximum fill patterns includes: detecting stable periods in the fuel level sensor data during refueling events; filtering out sensor readings caused by fuel movement; and clustering stable sensor readings to identify consistent maximum levels.

In some implementations, the techniques described herein relate to a non-transitory computer-readable storage medium, the steps further including: receiving a vehicle location from the vehicle gateway device; obtaining a merchant location associated with the fuel dispensing event data; calculating a distance between the vehicle location and the merchant location; and validating the fuel dispensing event data based on the distance.

In some implementations, the techniques described herein relate to a non-transitory computer-readable storage medium, the steps further including: detecting a connection between a driver application and the vehicle gateway device; receiving image data from an AI camera system in a vehicle; performing driver identification analysis on the image data; and establishing a driver-vehicle correlation based on at least one of: the connection or the driver identification analysis.

In some implementations, the techniques described herein relate to a non-transitory computer-readable storage medium, wherein computing the confidence score includes: analyzing variations in the sensor calibration ratio across multiple refueling events; determining a statistical consistency of maximum fill levels; and adjusting the confidence score based on a number of analyzed refueling events.

In some implementations, the techniques described herein relate to a non-transitory computer-readable storage medium, wherein validating fuel dispensing operations includes: receiving a new fuel purchase amount; comparing the new fuel purchase amount to an expected tank level change based on the fuel container capacity; and generating a response to the fuel dispensing operations in response to comparing the new fuel purchase amount to the expected tank level change.

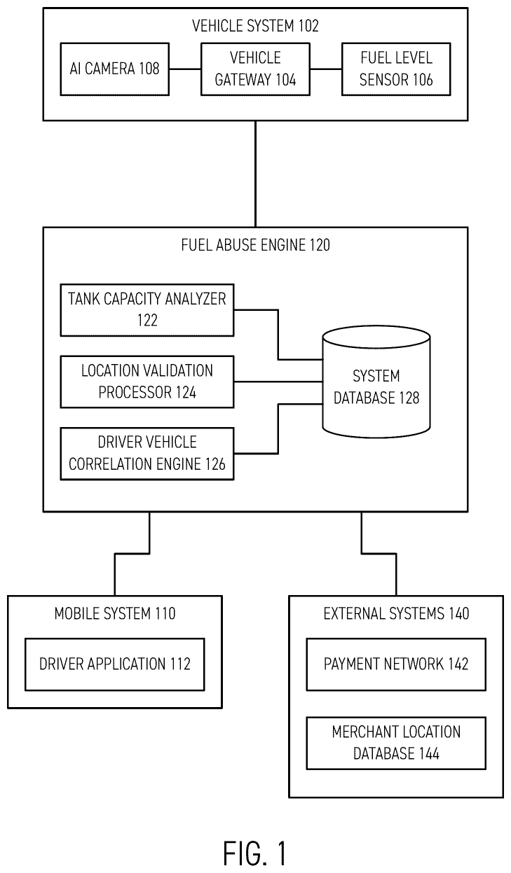

FIG. 1 is a block diagram illustrating a system for analyzing vehicle refueling patterns according to some of the disclosed embodiments.

In the illustrated embodiment, the system includes a vehicle system 102 that interfaces with a fuel abuse engine 120. The vehicle system 102 includes a vehicle gateway 104 that serves as a central communication hub for vehicle-based sensors and devices. The vehicle gateway 104 is communicatively coupled to a fuel level sensor 106 and an AI camera 108. The fuel level sensor 106 provides continuous monitoring of fuel tank levels and can detect changes in fuel volume over time. The AI camera 108 may be used for driver identification and verification purposes, capturing image data from within the vehicle cabin.

Modern vehicle fuel systems typically implement a complex array of sensors and control systems to manage fuel delivery and monitoring. The fuel level sensor generally operates using a float mechanism connected to a measurement sensor, which converts the physical position of the float into an electrical signal. This signal is then processed by the vehicle's Engine Control Unit (ECU) and transmitted over the Controller Area Network (CAN) bus. The vehicle gateway 104 and/or AI camera 108 interfaces with the CAN bus via, for example, a diagnostic port (such as an OBD-II port) to capture this fuel level data. However, these signals can be affected by various factors including vehicle movement, fuel sloshing, and temperature variations. Additionally, many commercial vehicles implement auxiliary or modified fuel containers or tanks that aren't reflected in the standard vehicle specifications. These modifications can significantly alter the relationship between the sensor readings and actual fuel volumes, necessitating analysis to establish accurate correlations.

The vehicle gateway 104 and/or AI camera 108 aggregates data from these sensors and provides a standardized interface for transmitting the sensor data to other system components. In some implementations, the vehicle gateway 104 and/or AI camera 108 may include local processing capabilities to perform initial data filtering and formatting before transmission. The vehicle gateway 104 may also implement various communication protocols to ensure reliable data transmission even in areas with limited connectivity. The vehicle gateway 104 may employ edge processing capabilities to handle signal noise and calibration variations in the raw sensor data before transmission to the central system.

The AI camera 108 comprises a dual-lens camera system mounted on the vehicle windshield, incorporating both forward-facing and cabin-facing image sensors. The camera system implements on-device machine learning models using a multi-task neural network architecture. This architecture consists of a convolutional neural network (CNN) backbone coupled to a feature pyramid network (FPN), which feeds into multiple specialized detection heads. Each detection head is optimized for specific tasks such as driver identification, facial analysis, and behavior monitoring. The camera system processes image streams in real-time using these on-device models to perform continuous driver monitoring and identification. The camera's neural network architecture enables efficient parallel processing of multiple detection tasks while maintaining low latency for real-time operation.

The system further includes a mobile system 110 that operates independently of the vehicle system 102. The mobile system 110 includes a driver application 112 that may be executed on a mobile device such as a smartphone or tablet. The driver application 112 can provide location data, driver identification information, and other contextual data that complements the vehicle-based sensors. In some implementations, the driver application 112 may implement background location tracking with adaptive sampling rates to optimize battery usage while maintaining location accuracy during critical events.

The fuel abuse engine 120 serves as the central processing hub for the system, receiving and analyzing data from both the vehicle system 102 and mobile system 110. The fuel abuse engine 120 implements several processing components that communicate and analyze vehicle refueling patterns and detect anomalies.

The fuel abuse engine 120 implements real-time transaction control mechanisms based on continuous fuel level monitoring. This container or tank capacity analyzer 122 maintains an active model of each vehicle's current fuel level by combining the calibrated sensor readings with recent refueling events. When a new transaction request is received, the system calculates the vehicle's current fuel capacity utilization using temperature-compensated sensor readings and configurable threshold parameters. The fuel abuse engine 120 employs predictive algorithms to account for fuel consumption between the last sensor reading and the transaction time, using vehicle telemetry data such as engine load and road grade. In addition to transaction-based monitoring, the fuel abuse engine 120 may also detect anomalous fuel level decreases independent of transaction data. In some implementations, the fuel abuse engine 120 can continuously monitor successive fuel level measurements to identify sudden or unexpected drops that cannot be explained by normal vehicle operation patterns. When the fuel abuse engine 120 detects a significant decrease in fuel level without corresponding engine usage data or an associated fueling transaction, it can flag this event as a potential fuel theft or siphoning incident. This detection capability can operate agnostically of container capacity estimates, allowing for identification of fuel theft even in vehicles with uncertain or uncalibrated tank parameters. The fuel abuse engine 120 can distinguish between normal fuel consumption patterns and suspicious rapid decreases by analyzing the rate of change, time of occurrence, vehicle operating status, and historical usage patterns. This real-time monitoring enables the system to automatically decline transactions when the current fuel level exceeds configurable thresholds, preventing physically impossible fill amounts while accounting for variations in fuel density and temperature.

The tank capacity analyzer 122 within the fuel abuse engine 120 implements algorithms to dynamically determine vehicle fuel container or tank capacities without requiring prior knowledge of the vehicle specifications. This is particularly important for vehicles with modified or auxiliary fuel containers or tanks. The tank capacity analyzer 122 processes historical refueling data along with real-time fuel level sensor readings to establish baseline container or tank capacity estimates. In some implementations, the tank capacity analyzer 122 may employ statistical modeling techniques to account for variations in fuel level sensor readings and establish confidence intervals for its capacity estimates. The tank capacity analyzer 122 may also implement adaptive learning algorithms that can detect and adjust to changes in container or tank capacity over time, such as when auxiliary container or tanks are added or removed. In an alternative implementation, the system can detect fuel discrepancies by analyzing engine consumption data alongside refueling records. Rather than relying solely on historical refueling data to establish expected patterns, the system can index expectations on fuel consumption metrics obtained directly from the vehicle's engine control systems. By comparing the volume of fuel purchased over a specific timeframe with the actual fuel consumed by the engine during the same period, the system can identify significant discrepancies that may indicate potential fuel misuse. This consumption-based method provides an independent verification mechanism that complements the tank capacity estimation approach, enabling detection of anomalies even when historical refueling data is limited or inconclusive. In some implementations, the method of validating fuel dispensing operations includes a comparison between the transaction data and sensor data. Rather than simply comparing the new fuel purchase amount directly to the total container capacity, the system compares the purchase amount to the expected change in tank level that should result from the transaction. The system calculates this expected change based on the estimated container capacity, the current fuel level before the transaction, and the calibrated relationship between sensor readings and actual fuel volumes. For example, if a transaction indicates 40 gallons were purchased, but the tank level sensor data indicates the fuel level only increased by an amount equivalent to 30 gallons based on the tank's calibration model, the system would flag this 10-gallon discrepancy as a potential anomaly. This more granular comparison allows the system to detect partial discrepancies where the total purchase amount might be within the vehicle's total capacity but inconsistent with the actual change in fuel level observed through sensor data.

The location validation processor 124 correlates vehicle location data from multiple sources to establish ground truth about merchant locations and vehicle positions during refueling events. The location validation processor 124 may implement various spatial analysis algorithms to account for GPS accuracy limitations and establish confidence scores for location matches. In some implementations, the location validation processor 124 may maintain a dynamic database of verified merchant locations based on repeated successful correlations between vehicle position data and merchant records. The location validation processor 124 may also implement geofencing algorithms with dynamic radius calculations based on the urban density and GPS signal quality of different areas.

The location validation processor 124 can implement a merchant location verification system that builds and maintains a dynamic accuracy model for each fueling location. Rather than relying solely on third-party merchant location data, which can be inaccurate or outdated, the system aggregates telematics data from multiple vehicles during verified refueling events to establish ground truth coordinates for each merchant. The location validation processor 124 employs clustering algorithms to identify consistent vehicle positions during refueling operations, weighted by GPS accuracy metrics and the number of successful transactions. This data is used to construct and continuously update geofence polygons that more accurately represent the physical boundaries of each fueling location. The system maintains separate confidence scores for merchant locations based on factors such as the consistency of vehicle positions, the recency of verification data, and the quality of GPS signals in the area. In some implementations, the location validation processor 124 can build and maintain a whitelist of validated merchant locations. For example, when third-party merchant location data is ingested into the system, the location validation processor 124 can analyze telematics information from vehicles that have conducted transactions at these locations. By examining patterns of vehicle presence at suggested merchant coordinates, the system can validate location accuracy. Merchants frequented by multiple vehicles during verified fuel transactions receive higher confidence scores and are added to a whitelist of qualified locations. This whitelist is continuously updated as new telematics data becomes available, improving the system's ability to distinguish between accurate and potentially inaccurate merchant location data.

The driver vehicle correlation engine 126 implements matching algorithms to establish relationships between specific drivers and vehicles. The driver vehicle correlation engine 126 processes multiple data streams including AI camera 108 feeds, mobile device locations, and manual vehicle assignments to establish these correlations with various levels of confidence. The correlation confidence levels may be used by other system components to adjust their analysis parameters accordingly. The driver vehicle correlation engine 126 may implement temporal analysis algorithms to detect patterns in driver-vehicle assignments and automatically adapt to regular rotation patterns in fleet operations.

The driver vehicle correlation engine 126 implements real-time case matching through a multi-stage verification pipeline. When processing a new transaction request, the driver vehicle correlation engine 126 first queries its active correlation cache, which maintains recent high-confidence matches from authenticated device pairings and AI camera identifications. If no active correlation is found, the driver vehicle correlation engine 126 initiates parallel verification processes across all available data sources, implementing race conditions and timeout mechanisms to ensure rapid response times. The driver vehicle correlation engine 126 employs adaptive weighting algorithms that adjust the confidence thresholds based on historical accuracy rates for each verification method in different operating conditions. This real-time correlation system enables the driver vehicle correlation engine 126 to maintain accurate driver-vehicle relationships even in dynamic fleet operations where drivers frequently switch vehicles or operate multiple vehicles during a shift.

The system database 128 stores the processed data and analysis results from all components of the fuel abuse engine 120. In some implementations, the system database 128 may implement a time-series architecture optimized for storing and querying temporal patterns in vehicle operation data. The system database 128 may also maintain historical analysis results to enable pattern detection across extended time periods. The system database 128 may implement partitioning strategies to optimize query performance across different time scales, from real-time analysis to historical pattern detection.

The system interfaces with external systems 140 including a payment network 142 and merchant location database 144. The payment network 142 provides fuel dispensing event data (including, but not limited to, transaction data associated with refueling locations) that can be correlated with the vehicle sensor data and location information. The merchant location database 144 provides reference data for merchant locations that can be validated and enhanced through the system's location correlation capabilities. The system implements standardized integration interfaces that can adapt to various external data formats and protocols while maintaining consistent internal data representations.

The interconnections between system components enable real-time analysis of vehicle refueling patterns. For example, when the vehicle gateway 104 transmits a fuel level change event from the fuel level sensor 106, the tank capacity analyzer 122 can immediately compare this against its learned capacity model for that specific vehicle. Simultaneously, the location validation processor 124 can correlate the vehicle's position with known merchant locations, while the driver vehicle correlation engine 126 confirms the expected vehicle-driver relationship.

In some implementations, the system may employ various communication protocols optimized for the different types of data being transmitted. For example, fuel level sensor data may be transmitted using a protocol optimized for time-series data, while location data may use a protocol designed for efficient transmission of geometric coordinates. The system may also implement various data compression and buffering strategies to handle scenarios with limited network connectivity. These protocols may include automatic retry mechanisms with exponential backoff to handle temporary network interruptions while maintaining data consistency.

The system architecture enables extensibility through its modular design. Additional analysis components can be added to the fuel abuse engine 120 as new types of sensors or data sources become available. Similarly, the system can be adapted to interface with different types of external systems 140 through standardized integration interfaces. The modular architecture allows for independent scaling of different components based on processing demands, with the ability to deploy additional instances of computationally intensive components like the tank capacity analyzer 122 or location validation processor 124 as needed.

Through this architecture, the system provides a comprehensive technical solution for analyzing vehicle refueling patterns through the correlation of multiple data sources and real-time analysis algorithms. The system's modular design and extensible architecture enable it to adapt to new requirements and data sources while maintaining robust security and reliability characteristics. The integration of vehicle systems, mobile applications, and external data sources creates a robust platform for detailed analysis of vehicle operations that can scale to support large fleet operations while maintaining high performance and data accuracy.

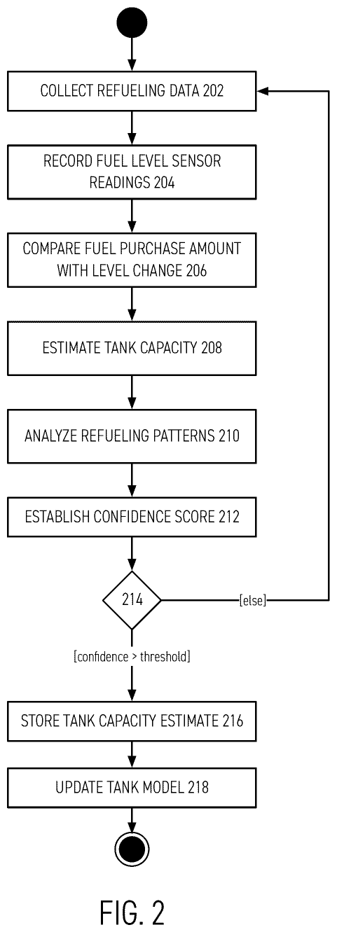

FIG. 2 is a flow diagram illustrating a method for determining vehicle fuel tank capacity using sensor data analysis according to some of the disclosed embodiments.

In step 202, the method includes collecting refueling data from multiple sources.

In some implementations, the method can be triggered by various events, such as the initial deployment of a vehicle gateway device, the detection of potential tank modifications, or periodic system calibration cycles. Additionally, the method can be initiated by fuel transactions, detected refuel events identified through fuel level sensor changes, sudden decreases in tank level, or other significant changes in monitored fuel metrics. In some implementations, this data collection process involves aggregating historical transaction records, fuel level sensor readings, and vehicle telemetry data. In some implementations, this data collection process involves aggregating historical transaction records, fuel level sensor readings, and vehicle telemetry data. The method may establish a baseline dataset that includes multiple refueling cycles to ensure statistical significance. In some implementations, the data collection process may implement adaptive sampling rates based on the frequency of refueling events and the stability of sensor readings.

In step 204, the method includes recording fuel level sensor readings during refueling events.

The fuel level sensor typically provides analog signals that are converted to digital values by the vehicle's ECU. In some implementations, the method samples these readings at a high frequency during detected refueling events to capture the detailed characteristics of the tank filling process. The method may implement various signal processing techniques to filter out noise caused by fuel slosh, vehicle movement, or sensor irregularities. In some implementations, the method may also record ambient temperature and vehicle inclination data to account for environmental factors that could affect sensor readings.

In step 206, the method compares the fuel purchase amount with the corresponding change in fuel level sensor readings.

In some implementations, this comparison establishes a relationship between the volume of fuel added and the change in sensor output. In some implementations, the method may implement a sliding window analysis to identify stable periods during the refueling process, avoiding transitional states where fuel movement might affect readings. The method may also account for variations in fuel density due to temperature or fuel type differences.

In step 208, the method implements a regression-based approach to estimate tank capacity using multiple data points that correlate fuel purchase amounts with corresponding percentage changes in fuel level readings.

In some implementations, the method employs statistical regression techniques to analyze the relationship between known gallon amounts from transaction records and the percentage changes in fuel level sensor readings. This regression analysis serves to establish an estimated tank capacity without requiring a direct conversion between level changes and volume measurements. In some implementations, the method may account for non-linear sensor responses by applying appropriate statistical models to the collected data points. The method may also account for sensor deadbands at extreme readings (nearly empty or completely full) where sensor accuracy might be reduced, incorporating these variations into the regression model to improve estimation accuracy.

In step 210, the method analyzes refueling patterns across multiple refueling events.

In some implementations, the method may use statistical analysis techniques to identify patterns across multiple refueling events, regardless of whether they represent maximum fill levels or partial refills, allowing the system to establish reliable tank capacity estimates from diverse refueling behaviors. The method may also implement outlier detection to identify and exclude anomalous readings that could skew the capacity estimation.

In step 212, the method establishes a confidence score for the tank capacity estimate.

In some implementations, this score is computed based on various factors including the consistency of measurements, the number of refueling events analyzed, and the quality of sensor data. In some implementations, the confidence score may be calculated using a weighted combination of factors such as the standard deviation of fill ratios, the number of consistent maximum fill events, and the stability of sensor readings during filling operations.

In step 214, the method evaluates whether the confidence score exceeds a predetermined threshold.

In some implementations, this threshold may be dynamically adjusted based on the specific requirements of the application and the characteristics of the vehicle fleet. In some implementations, the threshold may vary based on factors such as vehicle type, fuel tank configuration, and operational requirements.

If the confidence score does not exceed the threshold, the method returns to step 202 to collect additional refueling data. This feedback loop ensures that the system continues to gather data until it can establish a sufficiently reliable tank capacity estimate. In some implementations, the method may adjust its data collection parameters based on the specific factors that contributed to the low confidence score.

If the confidence score exceeds the threshold, the method proceeds to step 216, where it stores the tank capacity estimate in the system database. In some implementations, this storage operation may include metadata such as the confidence score, the number of refueling events analyzed, and the date range of the analysis. The stored capacity estimate may also include confidence intervals or tolerance ranges to account for measurement uncertainties.

In step 218, the method updates the tank model used for ongoing fuel level analysis.

This model update incorporates the newly established tank capacity and calibration factors. In some implementations, the model may include parameters for temperature compensation, fuel density variations, and sensor non-linearity. The updated model may also incorporate learned patterns about sensor behavior under different operating conditions.

After step 218 the method may terminate. However, in some implementations, the method may continue to run periodically or in response to specific triggers to refine the tank capacity estimate over time. This ongoing calibration helps maintain accuracy as vehicle characteristics change due to aging, modifications, or repairs.

The method's adaptive approach to tank capacity determination enables it to handle a wide range of vehicle configurations, including those with modified or auxiliary fuel tanks. By establishing reliable tank capacity estimates, the method provides a foundation for accurate fuel level monitoring and anomaly detection in fleet operations. The continuous refinement of these estimates ensures that the system maintains its effectiveness even as vehicle characteristics change over time.

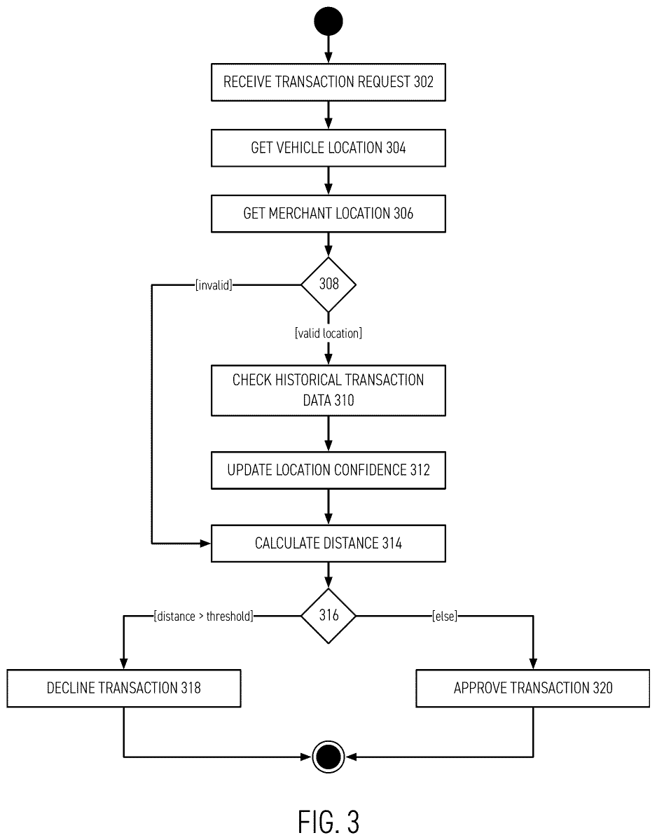

FIG. 3 is a flow diagram illustrating a method for validating transaction locations using real-time vehicle position data according to some of the disclosed embodiments.

In step 302, the method receives a transaction request from the payment network.

In some implementations, this request includes merchant identification data, timestamp information, and transaction metadata. The incoming request triggers a parallel processing pipeline that simultaneously queries vehicle location data and merchant location information. In some implementations, the method may also extract additional contextual data from the transaction request, such as the type of fuel, quantity, and other relevant transaction parameters that can be used for enhanced validation. The method operates continuously in response to incoming transaction requests, implementing real-time validation of spatial relationships between vehicles and merchant locations.

In step 304, the method retrieves the current vehicle location from the vehicle gateway system.

This location data typically can include GPS coordinates with associated accuracy metrics, heading information, and timestamp data. In some implementations, the method may implement a prediction algorithm to account for potential latency between the GPS reading and the transaction time. This prediction can be based on the vehicle's current velocity vector and historical movement patterns. The method may also implement various GPS error compensation techniques, such as Kalman filtering or dead reckoning, to improve location accuracy in challenging environments such as urban canyons or areas with poor satellite visibility.

In step 306, the method obtains the merchant location data from the merchant location database.

In some implementations, this data includes not only the merchant's primary coordinates but also additional spatial information such as property boundaries, multiple fuel pump locations, and entrance/exit points. The method may implement caching mechanisms to optimize frequent location lookups for commonly visited merchants. In some implementations, the method may also maintain a local database of frequently accessed merchant locations to reduce external database queries and improve response times.

In step 308, the method determines whether the merchant location has been previously validated.

In some implementations, this validation status reflects the system's confidence in the accuracy of the stored merchant location data. In some implementations, the validation process considers factors such as the number of successful transactions at the location, the consistency of vehicle positions during these transactions, and the quality of GPS signals in the area. The method may implement a multi-tier validation system where merchants can have different levels of location confidence based on the quantity and quality of historical fuel dispensing event data.

If the merchant location has not been validated, the method proceeds to step 310, where it analyzes historical fuel dispensing event data for the merchant location. This analysis examines patterns in previous transactions, including the distribution of vehicle positions, typical transaction durations, and timing patterns. In some implementations, the method may implement clustering algorithms to identify common vehicle positions during refueling events, which can help refine the merchant's true location. The method may also analyze transaction patterns across different times of day and different vehicle types to build a comprehensive understanding of the merchant's operational characteristics.

In step 312, the method updates the location confidence score for the merchant based on the historical analysis.

In some implementations, this confidence score is computed using a weighted combination of factors including the consistency of vehicle positions, the number of successful transactions, the average GPS accuracy in the area, and the temporal distribution of transactions. In some implementations, the method may implement adaptive weighting schemes that adjust the importance of different factors based on the local environment and transaction patterns. The confidence score update process may also consider external factors such as recent construction activity or changes in the merchant's business operations that could affect location accuracy.

Whether proceeding from step 308 or step 312, the method proceeds to step 314, where it calculates the distance between the vehicle's current position and the merchant location. In some implementations, this calculation uses geospatial algorithms that account for road network topology, physical barriers, and typical access patterns to the merchant location. The method may implement different distance calculation approaches based on the urban density and road network complexity of the area. For example, in dense urban environments, the method might use Manhattan distance calculations that better reflect actual travel distances, while in open areas, it might use direct Euclidean distance calculations.

In step 316, the method compares the calculated distance against a threshold value.

In some implementations, this threshold may be dynamically adjusted based on various factors including the merchant's validation status, the current GPS accuracy, and local environmental conditions. In some implementations, the method may implement a multi-threshold system that applies different distance requirements based on the merchant's location confidence score and historical transaction patterns. In some implementations, the threshold calculation may also consider factors such as the time of day, weather conditions, and known GPS interference sources in the area.

If the distance exceeds the threshold, the method proceeds to step 318, where it declines the transaction. In some implementations, the decline process includes generating detailed reason codes and logging the decision factors for future analysis. In some implementations, the method may implement different decline strategies based on the specific factors that triggered the distance threshold violation. For example, transactions that barely exceed the threshold with a highly validated merchant might trigger a different response than transactions with an unvalidated merchant location.

If the distance is within the acceptable threshold, the method proceeds to step 320, where it approves the transaction. In some implementations, the approval process includes updating transaction history records and merchant validation data based on the successful transaction. The method may also update its spatial models and confidence scores based on the newly confirmed transaction location.

In some implementations, the method can also analyze fuel tank data in parallel or in combination with the location-based validation described in FIG. 3. While the figure illustrates the location validation pathway, the method can further implement multiple validation pathways that can independently result in transaction approval or decline decisions.

In addition to the distance threshold comparison shown in step 316, the method can simultaneously evaluate fuel tank-related criteria using the tank capacity model established through the process described in FIG. 2. This parallel validation includes comparing the requested fuel amount against the vehicle's current fuel level, estimated remaining capacity, historical fueling patterns, and other tank-related metrics. Transactions may be declined if they would exceed the tank's physical capacity, if the current fuel level is above a configurable threshold (such as 90% capacity), if the requested amount is inconsistent with the vehicle's typical consumption patterns, or based on other fuel-related rule violations.

In some implementations, the final transaction decision can incorporate results from both the location-based validation pathway shown in FIG. 3 and the fuel tank-based validation pathway described above. In such implementations, a transaction must pass all applicable validation checks to receive final approval. In an alternative implementation, only the fuel tank analysis may be performed to approve or deny a transaction.

In some implementations, the method concludes after step 320 or step 318. However, in many implementations, the method continues to run continuously, processing new transaction requests as they arrive. The method maintains historical data and continuously refines its location validation models based on accumulated fuel dispensing event data.

The method's approach to location validation enables it to handle complex real-world scenarios while maintaining high accuracy in transaction validation. By combining real-time vehicle position data with historical transaction patterns and adaptive threshold calculations, the method provides robust protection against location-based transaction anomalies while minimizing false positives that could disrupt legitimate business operations.

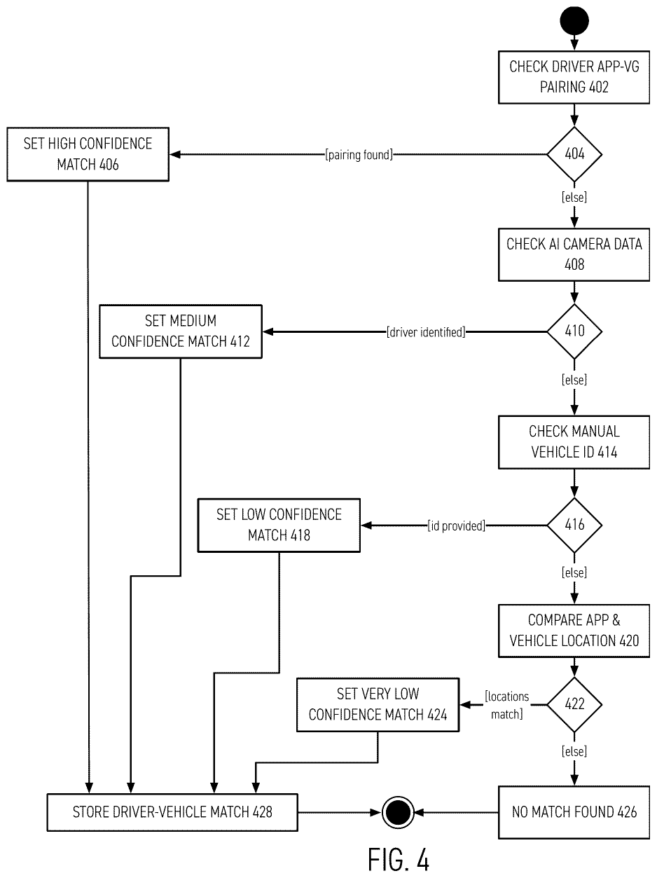

FIG. 4 is a flow diagram illustrating a method for establishing driver-vehicle mappings using multiple data sources according to some of the disclosed embodiments.

In step 402, the method checks for an active pairing between a driver's mobile application and a vehicle gateway device.

In some implementations, this pairing is established through a Bluetooth Low Energy (BLE) connection between the driver's mobile device and the vehicle gateway. In some implementations, the method may implement BLE scanning algorithms that account for signal strength variations and potential interference in the vehicle environment. The pairing process may include mutual authentication steps to ensure security and prevent unauthorized connections. This process can be triggered by various events, such as the initiation of a new trip, a driver login event, or a periodic validation check of existing mappings.

In step 404, the method determines whether a valid pairing exists.

In some implementations, the validation process examines both the technical connection status and the authentication state of the pairing. In some implementations, the method may also verify the temporal validity of the pairing, ensuring that it was established within an acceptable timeframe for the current operation.

If a valid pairing is found, the method proceeds to step 406, where it establishes a high-confidence match between the driver and vehicle. This high confidence level reflects the direct, authenticated connection between the driver's device and the vehicle's systems. In some implementations, the method may still perform additional validation checks even with high-confidence matches, particularly for security-sensitive operations.

If no valid pairing is found, the method proceeds to step 408, where it analyzes data from the vehicle's AI camera system. This camera system typically includes machine learning models trained for driver identification through facial recognition and other biometric indicators. In some implementations, the camera system may also analyze driver behavior patterns and physical characteristics to enhance identification accuracy.

In step 410, the method evaluates whether the AI camera system has successfully identified the driver. This evaluation considers factors such as the quality of the camera image, the confidence level of the facial recognition match, and the consistency of the identification across multiple frames. In some implementations, the method may implement temporal averaging of recognition results to improve reliability.

If the camera system successfully identifies the driver, the method proceeds to step 412, where it establishes a medium-confidence match. This confidence level reflects the strong but non-authenticated nature of visual identification. In some implementations, the method may adjust the confidence level based on the quality of the visual match and the lighting conditions.

If camera identification is unsuccessful, the method proceeds to step 414, where it checks for manually reported vehicle assignments. These assignments might come from fleet management systems, driver logs, or direct input from supervisory personnel. In some implementations, the method may implement validation checks on manual assignments to detect potential data entry errors or outdated information.

In step 416, the method determines whether a manual vehicle ID has been provided. This check includes verifying the recency and validity of the manual assignment. In some implementations, the method may implement time-based expiration of manual assignments to ensure that outdated information is not used for correlation.

If a manual ID is found, the method proceeds to step 418, where it establishes a low-confidence match. This lower confidence level reflects the potential for human error in manual data entry and the lack of technical verification. In some implementations, the method may implement additional validation checks for low-confidence matches when they are used for critical operations.

If no manual ID is available, the method proceeds to step 420, where it compares the locations of the driver's mobile device and the vehicle. In some implementations, this comparison involves spatial analysis that accounts for GPS accuracy limitations and potential signal delays. In some implementations, the method may implement predictive algorithms to account for movement during the location sampling process.

In step 422, the method determines whether the location data indicates a match. In some implementations, this determination considers factors such as GPS accuracy, temporal alignment of location samples, and movement patterns. In some implementations, the method may implement fuzzy matching algorithms that account for typical GPS error ranges in different environments.

If the locations match, the method proceeds to step 424, where it establishes a very low-confidence match. In some implementations, this confidence level reflects the inherent uncertainty in location-based matching and the potential for coincidental proximity. In some implementations, the method may require additional validation steps before using very low-confidence matches for any critical operations.

If no location match is found, the method proceeds to step 426, where it records that no match could be established. In some implementations, this outcome triggers appropriate system responses such as alerts or logging for further investigation.

For all successful matches (step 406, step 412, step 418, and step 424), the method proceeds to step 428, where it stores the driver-vehicle match along with its associated confidence level in the system database. In some implementations, this storage operation includes temporal metadata, match criteria, and any relevant validation data. In some implementations, the method may implement data versioning to maintain a history of driver-vehicle mappings over time.

The method concludes after step 426 or step 428. However, in many implementations, the correlation process runs continuously or periodically to maintain up-to-date driver-vehicle relationships. The method may also implement different validation frequencies based on the confidence level of existing mappings.

Throughout its operation, the method implements various error detection and handling mechanisms. For example, it may detect conflicting mappings, identify unusual patterns in driver-vehicle assignments, and flag potential security issues for investigation. The method may also implement different correlation strategies based on the operational context and security requirements of different fleet operations.

The method's multi-source approach to driver-vehicle correlation enables it to maintain reliable assignments even when individual data sources are unavailable or unreliable. By combining technical connections, visual identification, manual assignments, and location data with appropriate confidence levels, the method provides a robust foundation for fleet management and security operations.

The technical systems and methods described above enable various beneficial applications in fleet fuel management. For example, when the tank capacity analyzer 122 identifies a fuel purchase that exceeds the dynamically learned tank capacity for a specific vehicle, the system can automatically flag this as a suspicious transaction for investigation. Similarly, when the location validation processor 124 determines that a vehicle was not within a feasible distance of a merchant during a reported transaction time, the system can automatically decline the transaction before it is processed.

The driver vehicle correlation engine 126 provides additional verification capabilities by confirming whether the driver attempting to make a fuel purchase is actually operating the intended vehicle at the time of the transaction. By maintaining a continuous record of driver-vehicle relationships with associated confidence levels, the system can detect scenarios where a driver attempts to purchase fuel for an unassigned vehicle or when multiple transactions occur simultaneously with the same driver credentials.

The system's ability to process these mappings in real-time enables proactive transaction control rather than just after-the-fact detection. Fleet managers can configure automatic decline thresholds based on their risk tolerance and operational requirements. For example, they might choose to automatically decline transactions where the vehicle is more than a certain distance from the merchant, or where the purchase amount would exceed the vehicle's available tank capacity by a specified percentage. In some implementations, the method can decline transactions based on various threshold conditions beyond just exceeding the estimated tank capacity. For example, transactions may be declined if the current fuel level is above a configurable percentage threshold (such as 90% of capacity), preventing unnecessary small fills that may indicate fraudulent activity. In some implementations, the method can also implement time-based rules, such as declining transactions that occur within a minimum time interval from previous refueling events, or volume-based rules that flag unusual purchasing patterns regardless of total capacity. The system can also provide detailed analytics on fueling patterns across the fleet, helping managers identify unusual patterns that might indicate operational inefficiencies or potential misuse of fuel purchasing credentials.

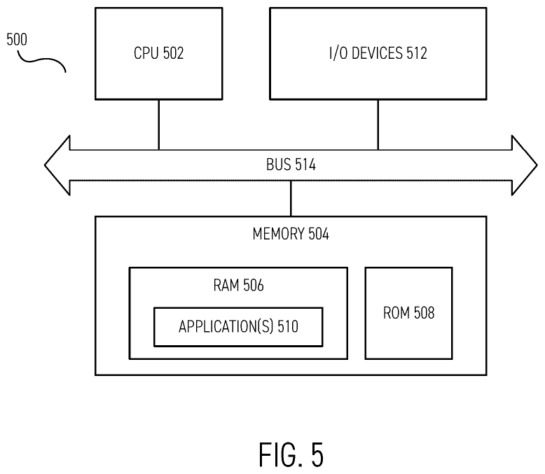

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A system comprising:
a vehicle including:
a fuel container;
a vehicle gateway device coupled to a fuel level sensor configured to generate fuel level signals and configured to transmit fuel level sensor data; and
a camera system configured to capture driver identification data; and
a remote computing system including a processor and a memory storing instructions that, when executed by the processor, cause the processor to:
receive the fuel level sensor data from the vehicle gateway device;
collect fluid dispensing event data; compare changes in the fuel level sensor data with fluid volume amounts to establish a sensor calibration ratio;
identify maximum fill patterns across multiple fluid level change events;
compute a confidence score based on consistency of the maximum fill patterns;
determine a container capacity when the confidence score exceeds a threshold; and
validate fluid dispensing operations using the container capacity.

2. The system of claim 1, wherein identifying maximum fill patterns comprises:
detecting stable periods in the fuel level sensor data during refueling events;
filtering out sensor readings caused by fuel movement; and
clustering stable sensor readings to identify consistent maximum levels.

3. The system of claim 1, the instructions further causing the processor to perform steps of:
receiving a vehicle location from the vehicle gateway device;
obtaining a merchant location associated with the fuel dispensing event data;
calculating a distance between the vehicle location and the merchant location; and
validating the fuel dispensing event data based on the distance.

4. The system of claim 1, the instructions further causing the processor to perform steps of:
detecting a connection between a driver application and the vehicle gateway device;
receiving image data from an AI camera system in a vehicle;
performing driver identification analysis on the image data; and
establishing a driver-vehicle correlation based on at least one of: the connection or the driver identification analysis.

5. The system of claim 4, wherein establishing the driver-vehicle correlation comprises assigning a confidence level based on a plurality of verification methods.

6. The system of claim 1, wherein computing the confidence score comprises:
analyzing variations in the sensor calibration ratio across multiple refueling events;
determining a statistical consistency of maximum fill levels; and
adjusting the confidence score based on a number of analyzed refueling events.

7. The system of claim 1, wherein validating fuel dispensing operations comprises:
receiving a new fuel purchase amount;
comparing the new fuel purchase amount to an expected tank level change based on the fuel container capacity; and
generating a response to the fuel dispensing operations in response to comparing the new fuel purchase amount to the expected tank level change.

8. A method comprising:
receiving, by a processor, fuel level sensor data from a vehicle gateway device, the vehicle gateway device communicatively couple to a fuel system of a vehicle via a diagnostic port;
collecting, by the processor, fuel dispensing event data;
comparing, by the processor, changes in the fuel level sensor data with fuel volume amounts to establish a sensor calibration ratio;
identifying, by the processor, maximum fill patterns across multiple fuel level change events;
computing, by the processor, a confidence score based on consistency of the maximum fill patterns;
determining, by the processor, a fuel container capacity when the confidence score exceeds a threshold; and
validating, by the processor, fuel dispensing operations using the fuel container capacity.

9. The method of claim 8, wherein identifying maximum fill patterns comprises:
detecting stable periods in the fuel level sensor data during refueling events;
filtering out sensor readings caused by fuel movement; and
clustering stable sensor readings to identify consistent maximum levels.

10. The method of claim 8, further comprising:
receiving a vehicle location from the vehicle gateway device;
obtaining a merchant location associated with the fuel dispensing event data;
calculating a distance between the vehicle location and the merchant location; and
validating the fuel dispensing event data based on the distance.

11. The method of claim 8, further comprising:
detecting a connection between a driver application and the vehicle gateway device;
receiving image data from an AI camera system in a vehicle;
performing driver identification analysis on the image data; and
establishing a driver-vehicle correlation based on at least one of: the connection or the driver identification analysis.

12. The method of claim 11, wherein establishing the driver-vehicle correlation comprises assigning a confidence level based on a plurality of verification methods.

13. The method of claim 8, wherein computing the confidence score comprises:
analyzing variations in the sensor calibration ratio across multiple refueling events;
determining a statistical consistency of maximum fill levels; and
adjusting the confidence score based on a number of analyzed refueling events.

14. The method of claim 8, wherein validating fuel dispensing operations comprises:
receiving a new fuel purchase amount;
comparing the new fuel purchase amount to an expected tank level change based on the fuel container capacity; and
generating a response to the fuel dispensing operations in response to comparing the new fuel purchase amount to the expected tank level change.

15. A non-transitory computer-readable storage medium for tangibly storing computer program instructions capable of being executed by a computer processor, the computer program instructions defining steps of:
receiving fuel level sensor data from a vehicle gateway device, the vehicle gateway device communicatively couple to a fuel system of a vehicle via a diagnostic port;
collecting fuel dispensing event data;
comparing changes in the fuel level sensor data with fuel volume amounts to establish a sensor calibration ratio;
identifying maximum fill patterns across multiple fuel level change events;
computing a confidence score based on consistency of the maximum fill patterns;
determining a fuel container capacity when the confidence score exceeds a threshold; and
validating fuel dispensing operations using the fuel container capacity.

16. The non-transitory computer-readable storage medium of claim 15, wherein identifying maximum fill patterns comprises:
detecting stable periods in the fuel level sensor data during refueling events;
filtering out sensor readings caused by fuel movement; and
clustering stable sensor readings to identify consistent maximum levels.

17. The non-transitory computer-readable storage medium of claim 15, the steps further comprising:
receiving a vehicle location from the vehicle gateway device;
obtaining a merchant location associated with the fuel dispensing event data;
calculating a distance between the vehicle location and the merchant location; and
validating the fuel dispensing event data based on the distance.

18. The non-transitory computer-readable storage medium of claim 15, the steps further comprising:
detecting a connection between a driver application and the vehicle gateway device;
receiving image data from an AI camera system in a vehicle;
performing driver identification analysis on the image data; and
establishing a driver-vehicle correlation based on at least one of: the connection or the driver identification analysis.

19. The non-transitory computer-readable storage medium of claim 15, wherein computing the confidence score comprises:
analyzing variations in the sensor calibration ratio across multiple refueling events;
determining a statistical consistency of maximum fill levels; and
adjusting the confidence score based on a number of analyzed refueling events.

20. The non-transitory computer-readable storage medium of claim 15, wherein validating fuel dispensing operations comprises:
receiving a new fuel purchase amount;
comparing the new fuel purchase amount to an expected tank level change based on the fuel container capacity; and
generating a response to the fuel dispensing operations in response to comparing the new fuel purchase amount to the expected tank level change.
